(19) United States
(12) Patent Application Publication
(10) Pub. No.: US 2026/0093602 A1
(43) Pub. Date: Apr. 2, 2026

(54) Method for Static Analysis of Source Code Expressed in One of a Plurality of Different Programming Languages

(71) Applicant: Endor Labs Inc, Palo Alto, CA (US)

(72) Inventor: Barend Hermanus VENTER, Bothell, WA (US)

(73) Assignee: Endor Labs Inc, Palo Alto, CA (US)

(21) Appl. No.: 19/344,858

(22) Filed: Sep. 30, 2025

Related U.S. Application Data
(60) Provisional application No. 63/700,934, filed on Sep. 30, 2024.

(51) Int. Cl. G06F 11/3604

(52) U.S. Cl. CPC G06F 11/3608; G06F 8/41; G06F 8/44

(57) ABSTRACT

The invention provides a method for performing static analysis of source code of a computer program. The invention can be applied to source code of computer programs that are each written in one or more computer programming languages. The source code is translated into a byte code program which is processed by a virtual machine (VM). The VM performs static analysis of the source code via the translated byte code program and the VM is further designed to distinguish between different types of functions. An external function, such as a computer programming language intrinsic function, is processed by a language specific plug-in module (LSPM) that interoperates with the VM. After processing of the function call by the LSPM, the LSPM updates the state of execution of the VM, and control of execution returns from the LSPM to the virtual machine (VM).

This document is a United States Non-provisional utility patent application under statute 35 U.S.C. 111(A). This document claims priority and benefit to a U.S. Provisional utility patent application that is identified by a Serial No: 63/700,934 and that is titled “STATIC ANALYSIS OF SOURCE CODE EXPRESSED IN ONE OF A PLURALITY OF DIFFERENT COMPUTER PROGRAMMING LANGUAGES”, and that was filed with the U.S. Patent and Trademark Office (USPTO) on Sep. 30, 2024. All of the above referenced documents are herein incorporated by reference in their entirety.

### BACKGROUND OF THE INVENTION

Static source code analysis is a method of examining and analyzing the source code of a computer program for the purpose of identifying defects within the computer program. Such static analysis does not require a full execution of the computer program to perform this type of analysis. The above description is provided for general background information and is not intended to be used as an aid in determining the scope of the claimed subject matter.

### BRIEF DESCRIPTION OF THE INVENTION

The invention provides a system, apparatus and method for performing static analysis of source code that is included within a software application, which is also referred to herein as a computer program. The source code can be written in a plurality of one or more different programming languages. The system, apparatus and method can be applied to different software applications that are written in a plurality of one or more computer programming languages.

The source code is translated (compiled into a byte code) by a translator program. The byte code is processed by a virtual machine (VM). The virtual machine (VM) performs static analysis of the source code via the translated byte code, and the virtual machine (VM) is designed to distinguish between calls to functions which are defined (expressed) in terms of byte codes, and calls to “external” functions that are not defined (expressed) in terms of byte codes, but are instead defined (implemented) in software being located outside of the translated byte code.

Such software that is located outside of the translated byte code can be located in association with and/or within an operating system, or within a runtime environment that is associated with the particular programming language from which the source code is expressed, and that is being statically analyzed by the virtual machine (VM).

Calls to external functions, including functions that are intrinsic to a computer programming language, also referred to herein as language intrinsic functions (LIF), are processed via a language specific plug-in module (LSPM), that interoperates with the virtual machine (VM). After processing of a call to a language intrinsic function (LIF) by the LSPM, the LSPM updates the state of execution of the virtual machine (VM), and then returns control of execution from the LSPM to the virtual machine (VM).

This brief description of the invention is intended only to provide an overview of subject matter disclosed herein according to one or more illustrative embodiments and does not serve as a guide to interpreting the claims or to define or limit the scope of the invention, which is defined only by the appended claims.

### BRIEF DESCRIPTION OF THE DRAWINGS

So that the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention can encompass other equally effective embodiments.

The drawings are not necessarily to scale. The emphasis of the drawings is generally being placed upon illustrating the features of certain embodiments of the invention. In the drawings, like numerals are used to indicate like parts throughout the various views. Differences between like parts may cause those parts to be indicated with different numerals. Unlike parts are indicated with different numerals. Thus, for further understanding of the invention, reference can be made to the following detailed description, read in connection with the drawings in which:

FIG. 1 illustrates a simplified representation of at least one embodiment of the operation of the invention.

FIG. 2 illustrates a simplified representation of the internal structure of an embodiment of the static analyzer program (SAP) of FIG. 1.

FIG. 3 illustrates a simplified representation of an embodiment for processing a byte code (BC) program, via interoperation between the virtual machine (VM) and the language specific plugin module (LSPM).

FIG. 4 illustrates a simplified representation of an embodiment of a computing environment within which the static analyzer program (SAP) 110 can operate.

### DETAILED DESCRIPTION OF THE INVENTION

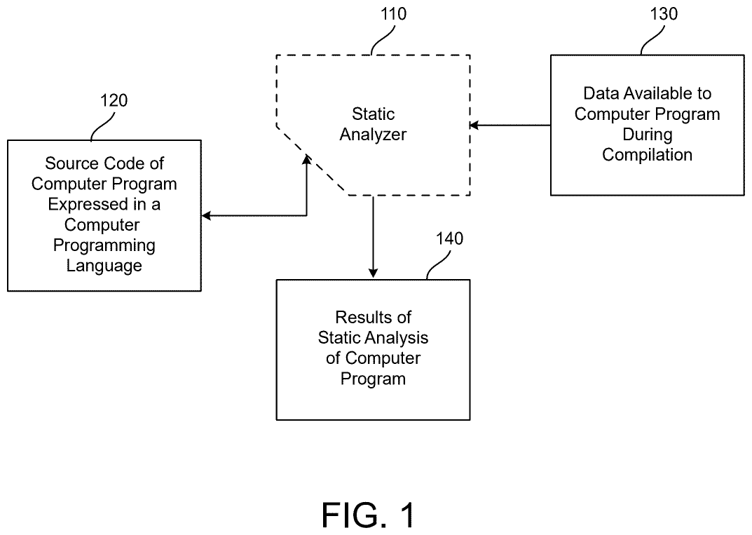

FIG. 1 illustrates a simplified representation of a system of operation of at least one embodiment of the invention. As shown, a static analyzer program (SAP) 110 is designed (configured) to input and process one or more files including source code that collectively constitute a software application, which is also referred to herein as a computer program 120. This source code 120 is expressed in compliance with a specification of at least one computer programming language.

The SAP 110 is also designed (configured) to input and process at least a portion of the data 130 that the source code of the computer program 120 is designed (configured) to input and process, during at least compilation of the computer program 120. Typically, this data 130 is stored into a configuration file and is designed (configured) to configure (influence) the operation of the computer program 120 during its execution phase.

For example, the source code of the computer program 120 can be designed (configured) to support operation of an internet accessible web page. How the source code is processed for execution is dependent upon which type of web browser program is interacting with the web page, at any given instance in time. The data 130 can be designed (configured) to indicate to the source code of the computer program 120, which type, and version of the web browser program is interacting with the web page at any given instance in time.

For example, the web browser program can be a Google Chrome browser program, as opposed to a Microsoft Edge browser program, or as opposed to a Mozilla Firefox browser program. In addition, the data 130 provides information so that the behavior of the computer program 120 can adapt to different types of web browser programs, and to further adapt to different versions of those web browser programs.

As an example, JavaScript is classified as a dynamic programming language, considering that this programming language is interpreted during its runtime execution phase and and/or that it provides for dynamic linking of functions (methods) during its runtime execution phase. However, prior to the runtime execution (interpretation) of the JavaScript source code, there is an execution of a compilation phase, which may be referred to as a pre-processing phase.

In some embodiments, the static analyzer program (SAP) 110 performs input/output of information (data) during the JavaScript compilation phase, to gather information from data that is stored, for example, inside of a configuration file. Accessing this configuration file data enables the SAP 110 to obtain additional information to support the static analysis of the JavaScript source code, considering that execution of the JavaScript source code and the behavior of the computer program associated with this source code depends at least in part, upon the actual data values stored inside of the configuration file. Exercising a portion of the source code while employing these data values, is referred to herein as performing a partial evaluation, as opposed to performing a full evaluation, of the source code of the computer program.

In some embodiments, static analysis employs symbolic execution of the source code of this computer program. With symbolic execution, a set of possible values, represented by a symbolic expression, is assigned to each variable within the source code, at different instances in time, based upon information available to the SAP 110. With such symbolic expression(s) providing partial information regarding the possible values of a variable at an instance in time, some portions (sections) of source code can be identified as being non-reachable and non-executable. Such non-reachable and non-executable portions (sections) of source code are also referred to as being “dead” source code, or simply as “dead” code.

Static analysis of source code can identify a path of execution through the source code where a value of a variable is relied upon by the source code, without that variable having been explicitly initialized to a specific value, prior to being relied upon. Static analysis can also identify a path of execution through the source code that can cause a memory leak within the computer program 120.

The SAP 110 is designed (configured) to output the results 140 of the static analysis processing that it 110 performs upon the source code of the computer program 120 in combination with the data 130, that is input into that computer program 120, during its compilation phase. The results of static analysis 140 are expressed as a set of data. In some embodiments of the SAP 110, the results 140 include information that enables construction of a function calling hierarchy of the computer program 120.

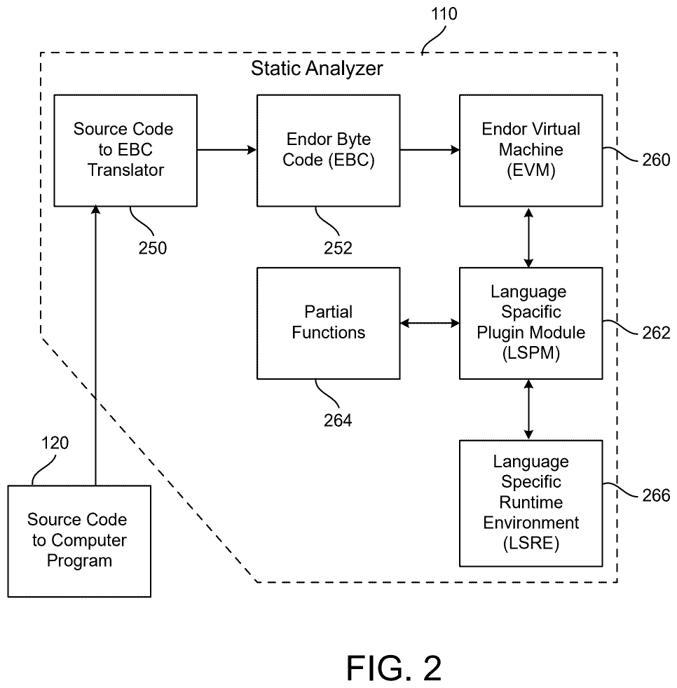

FIG. 2 illustrates a simplified representation of the internal structure of an embodiment the static analyzer program (SAP) 110. As shown, the SAP 110 includes a source code to byte code (BC) translator program 250, which is also referred to herein as a translator 250. This software component 250 functions as a computer programming language compiler and it is designed (configured) to translate source code that is expressed in compliance with a particular computer programming language, which is also referred to herein as a programming language, into a binary representation that is referred to herein as a set of byte code (BC) 252, or as a byte code program 252. The output of the translator program 250 being a set of byte code 252 which functions as a representation of at least one portion of a software application and/or a computer program that is expressed as source code in accordance with a computer programming language.

This byte code (BC) 252, which is also referred to herein as Endor Byte Code, is a binary representation of the source code 120, which is produced by the translator 250. The Endor byte code (BC) 252 is designed (configured) by the Endor Labs. What is referred to as byte code (BC) 252 herein, is a series (sequence) of instructions along with auxiliary data, implemented as structured binary data. Preferably, and in some embodiments, an individual byte code (BC) 252 is implemented as a software object. The software object is structured to include both software instructions and data, and where the data of the software object is accessed via methods. Methods are functions that are constructed from software instructions, and that are provided in association with the software object.

For example, in one embodiment, this translator software component 250 is designed (configured) to translate source code that is expressed in compliance with the JavaScript programming language, into an Endor Byte Code (BC) program 252. In another embodiment, this translator software component 250 is designed (configured) to translate source code that is expressed in compliance with the Python programming language, into an Endor Byte Code (BC) program 252.

In yet another embodiment, the translator 250 may be a collection (plurality) of translators, at least some of these translators which are each designed (configured) to translate source code that is expressed in compliance with some programming language, into an Endor Byte code (BC) program 252. The language specific portions of the byte code 252 are encoded as calls to one or more byte code external functions, including language intrinsic functions, that are each supplied by (defined within) the respective language specific runtime environments 266. Such language specific runtime environments 266, are also referred to herein as “language runtimes” 266 or as “runtimes” 266.

In such an embodiment of a collection of translators, incorporating a set of a plurality of one or more different computer programming language translators, each of the corresponding plurality of one or more programming languages to be translated will provide a language specific runtime environment 266, also referred to herein as a runtime mechanism 266, if applicable, for the processing of the calling of one or more external functions that are (intrinsically) defined within a language specific runtime environment 266, and that are associated with each respective one of the plurality of programming languages being translated via the translator 250.

In accordance with the invention, source code expressed in accordance with each separate and different computer programming language, residing within a software application (computer program) for static analysis, is supported by a respective separate and different language specific plugin module (LSPM) 262. Each such LSPM 262 being configured (designed (configured)) to support a respective separate and different programming language, expressing source code for static analysis within the software application.

The collection (plurality) of translators, as referred to above, can also include one or more translators of a type that is other than a computer programming language source code to Endor byte code (EBC) type of translator.

In some embodiments, this collection of translators can also include one or more byte code to byte code translators. For example, a byte code to byte code translator is designed (configured) to translate Java byte code (JBC) into Endor byte code (EBC) 252. The Java byte code (JBC) is also referred to herein as being a type of byte code that is expressed in accordance with a language, being a byte code standard that is referred to herein as byte code language, and specifically being a Java byte code language. The Java byte code language being in accordance with a Java byte code specification.

The Java computer programming language is translated (compiled) into Java byte code (JBC), which is input and processed by a Java Virtual Machine (JVM) program, for the purpose of executing (causing performance of) actions directed by the Java computer programming language. Many computer programming languages, other than the Java computer programming language, are or can be translated into Java byte code (JBC).

For example, a COBOL program including source code that is expressed in accordance with the COBOL computer programing language, can be compiled (also referred to as being cross-compiled) into Java byte code (JBC). Such cross-compiled Java byte code can be further translated, in accordance with the invention, into Endor byte code (EBC) 252. From there, the Endor virtual machine (EVM) 260 can perform static analysis upon the COBOL program via the processing of the Endor byte code (EBC), that was translated from the Java byte code (JBC), and that was cross-compiled (translated) from the COBOL source code of the COBOL program.

In one circumstance, source code residing within a portion of a software application (computer program), can be expressed in accordance with the COBOL computer programming language. Such a portion of the software application can be statically analyzed via translation of this portion of the software application, into Endor byte code (EBC). Such Endor byte code (EBC) can be combined with other Endor byte code (EBC) that is translated from other source code residing in another portion of the software application, and that is expressed in accordance another computer programming language, being other than COBOL.

As a result, embodiments of the invention enable static analysis of a software application that includes source code that is divided into a plurality of portions that are each expressed in accordance with a separate and different computer programming language.

The above-described feature of the invention, can also be applied to third party (provided) software (TPS), including functions that are directly called (directly function called) from the byte code program 252. For example, source code of a first portion of a software application can be expressed in accordance with the JavaScript computer programming language, while source code of a second portion of the software application, being third party (provided) software is expressed in accordance with the COBOL computer programming language, for example. Such COBOL source code of the second portion can be directly translated into EBC and joined (linked) with EBC that was translated from the source code of the first portion of the software application, being expressed in accordance with the JavaScript computer programming language.

The above-described feature of the invention, can be applied to third party (provided) software (TPS), that is not expressed in source code, but instead expressed in Java byte code (JBC). In this circumstance, the JBC that represents COBOL source code, is translated into EBC, via a JBC to EBC byte code to byte code translator, and the EBC representing the COBOL source code is joined (linked) with EBC that was translated from the source code of the non-third party provided portion of the software application.

In this circumstance, the virtual machine 260 can statically analyze the third party (provided) software (TPS), that is expressed in accordance with the COBOL computer programming language, and that is expressed in accordance with the Java byte code (JBC) compiled from the COBOL source code, and that is expressed as Endor byte code (EBC), translated from the Java byte code (JBC).

The above-described scenarios involving third party (provided) software applies to third party functions being directly called from within the Endor byte code program 252. In other words, the third party provided COBOL functions are directly called from the COBOL software and/or JavaScript software, residing inside of the Endor byte code program 252. Also, JavaScript functions can be directly called from the COBOL software, as well as being directly called from the JavaScript software, residing within the byte code program 252.

The virtual machine (VM) 260, which is also referred to herein as the Endor Virtual Machine (EVM) 260, is designed (configured) to input and process set of byte codes, these byte codes being included within a byte code (BC) program 252 that is the output from the translator component 250. The EVM 260, like the Endor Byte Code (EBC) 252, is designed (configured) by Endor Labs. Each byte code instruction (BCI) within the byte code (BC) program 252, represents an instruction that directs some (one or more) actions to be performed in accordance with the semantics of the source code of a particular programming language, from which the byte code (BC) program 252 was translated into.

An individual type of byte code instruction, the function call instruction, is classified as being a call to an internal function that is defined within the byte code program 252, or else, classified as being a call to an external function, that is not defined within the byte code program 252. An internal function is expressed (defined) as a sequence of byte code instructions within the byte code program 252. An external function is implemented (defined) somewhere other than from within the byte code program 252. Some external functions are classified as being intrinsic to a particular computer programming language and are each referred to herein as being a language intrinsic function (LIF).

A language intrinsic function (LIF) is an external function that represents a function that is designed (configured) to perform actions that are specific to the source code that is expressed in a particular programming language, and where that same source code is being processed by the translator 250 to generate the byte code 252. Such a language intrinsic function call, being an external type of function call, is performed not by the VM 260 directly, but instead performed indirectly via interaction (interoperation) between the VM 260 and the language specific plugin module (LSPM) 262.

A byte code instruction that represents an action that is not specific to one programming language, and that is considered a type of action that is common to, and that can be routinely performed by any one of multiple programming languages, is also referred to herein as a non-language intrinsic byte code instruction, or as a non-intrinsic byte code instruction. Such a non-intrinsic byte code instruction (action) is also referred to herein as being a computer programming language common or generic action, or as a common or generic (non-language intrinsic) byte code instruction or action.

When the VM 260 inputs and processes one byte code instruction within a byte code program, if the byte code instruction specifies an action that is generic, and non-language intrinsic (language specific), then the action is performed directly by the VM 260. However, if the byte code specifies a call to an external function, such as a language intrinsic function (LIF), such a call is not performed directly by the VM 260, and instead is directly performed by the language specific plugin module (LSPM) 262, via interoperation between the VM 260 and the language specific plugin module (LSPM) 262.

An external function can also be an operating system call function, or third party (provided) function, if other than being a language intrinsic function (LIF). In some circumstances, an external function, such as an operating system function, can optionally be configured to operate differently than it would normally operate. For example, an operating system call function which is designed (configured) to perform input/output of data, may be modified to not perform such input/output of data. If not configured to operate differently that it would normally operate, an external function that is an operating system function, is programmatically defined in software that is associated with and/or located inside of software that is located within an operating system

Apart from being language intrinsic or non-intrinsic, some byte code (BC) specified actions may intentionally, not be performed by the virtual machine 260 during static analysis. For example, in some circumstances, input/output actions, which are typically performed via an operating system function call, may be intentionally not performed. In this circumstance, the library of operating system call functions can be modified to perform differently than originally designed (configured), and configured to selectively not perform certain actions, to better interoperate with the static analysis being performed upon a computer program 120.

Although one or more operating system function calls may be performed indirectly via a call to the LSPM 262 from the EVM 260, such operating system function calls are generally not directly performed by the EVM 260 during static analysis of a byte code (BC) 252 program.

Such a modified function can be further modified to return a value other than a value that it would normally return, when performing input/output of data, as it was designed (configured) for. For example, such a modified function could be further modified to return a symbolic expression, as opposed to returning a numeric value, to support symbolic execution of the byte code program 252.

Such symbolic execution of the byte code program 252 can facilitate performing static analysis upon the byte code program 252. Such a modified function is also referred to herein as a partial function 264. A partial function 264 is also referred to herein as a modeled function 264, or as a stub function 264, or as a stub 264.

Upon being called directly or indirectly by the VM 260, such a modified function executes and receives any arguments that are passed by the VM 260, during a function call from the VM 260 to the modified function. If the call from the VM 260 to the modified function is for the purpose of performing an operating system call, or other type of external call, no such designed (configured) action, such as the input or output of data is performed by the modified function.

But however, this modified function may be instead configured (designed (configured)) to perform other actions. For example, the modified function may be configured (designed (configured)) to return a particular return value to the VM 260, without performing input/output, prior to returning control of execution to the VM 260. This return value can optionally be in the form of a symbolic expression, that is designed (configured) to support symbolic reasoning.

Otherwise, if a byte code (BC) 252 specifies an action that is internal (not external) to the byte code 252, then the VM 260 (directly) performs the action. Such an action could be, performing a sum of two numeric values, for example. Adding two numeric values is an action that is routinely performed by multiple different programming languages, and performed by each of the JavaScript, Python and Java programming languages, and performed without requiring an intrinsic function to be called to perform such an action. As a result, such a well-understood and simple action of adding two numeric values is common across multiple different programming languages and can be said to be common or generic to those programming languages.

But however, if a byte code (BC) specifies an action that is an external function, such as for example, a call to a function that is intrinsic to a computer programming language, then the VM 260 interoperates with and transfers control of execution to a Language Specific Plugin Module (LSPM) 262, by calling an entry point function (entry point) within the application programming interface (API) of the LSPM 262, to facilitate the execution of the external function that is intrinsic to a computer programming language, being a language intrinsic function (LIF).

The Language Specific Plugin Module (LSPM) 262, is a software component that is designed (configured) to perform calling (execution) of external functions, being functions that are defined external to the byte code 252 that is generated by the translator 250. External functions include those functions that are intrinsic (specific and not generic) to a particular computer programming language.

In accordance with the invention, there is a LSPM 262 that is preferably designed (configured) for each one of a plurality of one or more different computer programming languages. Furthermore, embodiments of the each LSPM 262 can be expanded (adapted) to interface with a particular computing environment, including a particular operating system, referred to herein as a target operating system (OS), upon which a computer program (software application) is being statically analyzed and designed (configured) to interface (interoperate) with.

Optionally and furthermore, a particular LSPM 262 can be custom designed (configured) (configured) to interface with external software that resides outside of the byte code program 252, and where such external software is other than software that is provided by an operating system. For example, such external software can include a particular configuration (mix) of third-party software that the software application is designed (configured) to interface (interoperate) with, via function calls from the source code of a particular computer programming language residing within the software application being statically analyzed. The particular LSPM 262 being designed (configured) to accommodate processing (cause performance (execution) of) function calls made from the source code of the particular computing programming language.

For example, a first embodiment of the LSPM 262 is designed (configured) for processing (performing) external functions, such as language intrinsic functions that are associated with the JavaScript programming language, A second embodiment of the LSPM 262 is designed (configured) for processing (performing) language intrinsic functions that are associated with the Python programming language. And a third embodiment of the LSPM 262 is designed (configured) for processing (performing) language intrinsic functions that are associated with the Java programming language. In accordance with the invention, other embodiments of the LSPM 262 are designed (configured) for processing (performing) language intrinsic functions that are associated with other programming languages, and for processing external functions of various operating systems and third party provided software.

Preferably, each LSPM 262 that is designed (configured) to process and cause performance (execution) of, a call to a language intrinsic function (LIF) of a particular computer programming language, is also designed (configured) to process, and cause performance (execution) of, calls from that language intrinsic function (LIF), to another function. Such another function can be a call to an operating system call function (OSCF). Each computer programming language is designed (configured) to structure data, such as arguments (parameters) to a function call, in a particular way. Hence, each computer programming language is designed (configured) to call a particular operating system call function in a particular way. Accordingly, each LSPM 262 is configured to process (cause performance (execution) of) language intrinsic function calls, and process (cause performance (execution) of) operating system call functions that are called from those language intrinsic function calls.

When language intrinsic function (LIF) is called from the VM 260, via interoperation with the LSPM 262, the LSPM 262 receives from the VM 260, a pointer to an address of structured byte code data, and preferably a pointer to an address of a software object, that represents the state of execution of the VM 260, in addition to data associated with the language intrinsic function (LIF). Upon completion of the processing (performing) of the language intrinsic function, the LSPM 262 modifies (reads and then writes) the state of execution of the VM 260 in accordance with any modification to the state of execution being caused by the calling (processing/performance) of the language intrinsic function (LIF) by the LSPM 262 and returns control of execution to the VM 260.

Upon returning the control of execution to the VM 260, the VM 260 proceeds to input and process the next byte code instruction of byte code 252, as if the VM 260 directly and completely performed and processed the intrinsic function call of the prior byte code 252.

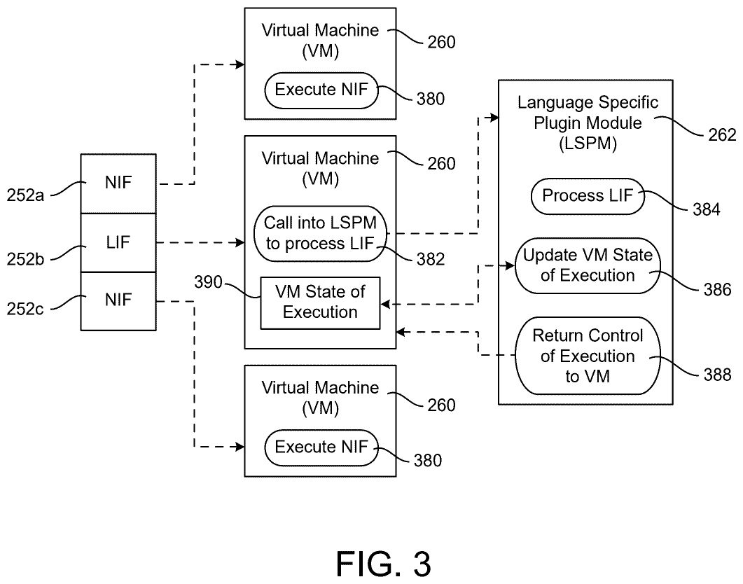

FIG. 3 illustrates a simplified representation of an embodiment for processing a sequence of byte codes (BC) 252a-252c, via interoperation between the virtual machine (VM) 260 and the language specific plugin module (LSPM) 262.

As shown, a series of byte codes (BC) in queued in sequence 252a-252c. The virtual machine 260 inputs (fetches) a first byte code 252a. The VM 260 inspects and classifies this first byte code 252a, as being associated with and directing a call of a non-intrinsic function (NIF), meaning that this byte code refers to a function by name, and instructs (directs) calling (causing performance) of the function. The function being defined to perform one or more action(s), and where performance (execution) of these actions does not require participation (processing) from the language specific plugin module (LSPM) 262.

In this circumstance, the function is called directly by the VM itself 260, and these one of more actions are directly performed, via the direct calling of the function 380, by the VM itself 260. This function, being a non-intrinsic type of function (NIF), includes content that is defined by a set of one or more bytecodes, where this set of bytecodes is a subset of the larger set of byte codes, within the byte code program 252, being generated by the source code to EBC translator 250. This subset of the translator generated byte code 252, is executed (performed) directly 380 by the VM itself 260. Upon performance (execution) of these actions and completion of processing of this byte code 252a, the VM 260 then turns its attention to and inputs (fetches) the next byte code 252b in sequence.

With respect to this second byte code 252b, the VM 260 inspects and classifies this second byte code 252b, as being associated with a language intrinsic function (LIF), which is also referred to herein as an “intrinsic function”, meaning that this byte code refers to an LIF function by name and it instructs the calling (causing performance) of the function. In this circumstance, the performance (execution) of the function requires interoperation between the VM 260 and the LSPM 262. The performance (processing) of this LIF function happens via the language specific plugin module (LSPM) 262.

In this circumstance, the VM 260 does not have access to a set of bytecodes defining the intrinsic function (LIF), within the generated bytecode program 252. The VM 260 then calls an entry point 382, being a function 382, also referred to herein as an entry point function 382, residing within an applications programming interface (API) of the LSPM 262. This entry point function 382 within the LSPM 262, is designed (configured) to cause processing of this byte code 252b, that directs processing of the language intrinsic function (LIF) 384. This LSPM function, receives a pointer to the byte code instruction 252b, and receives a pointer to the state of execution 390 of the VM 260.

Upon the calling of the entry point function of the LSPM 262, the entry point function retrieves a first argument associated with this byte code 252b, which identifies the LIF function by its alpha-numeric name, preferably encoded as a unique integer, and the entry point function further retrieves any of zero, one or more arguments from the byte code program 252, that are intended to be processed by the LIF function itself.

Preferably, an embodiment of the invention maps an alpha-numeric expressed name, such as a function name that is expressed via a text character string, for example, into a unique number, such as a unique integer as referred to above. Such a unique number can optionally function as an index value into structured data storing groupings of various types of information, as data. Such a programming technique can facilitate case and efficiency of software programming and of operation and performance (execution) of the software being programmed.

Upon obtaining the identity of the LIF function and the value(s) of its zero, one or more arguments, the LSPM 262 causes execution (calling) of the LIF function along with its zero, one or more arguments as data to be processed 384 by the LIF function. Such execution of the LIF function processes the byte code instruction 252b and causes performance (execution) of the one or more actions specified by the byte code instruction 252b, via access to the language specific runtime environment (LSRE) 266, that is associated with programming language of the source code from which the byte code program 252 was translated from by the translator 250. The LSRE 266 providing an application programming interface (API) through which the LSRE can be exercised from the LSPM 262. In other embodiments, the LSRE can be exercised directly from the virtual machine (VM) 260, via a same or another API.

The LSPM 262 is designed (configured) to map the function name of an external function, such as this LIF function, and designed (configured) to acquire a function signature of this external function, from information provided by the byte code 252b being processed by the virtual machine 260. The LSPM 262 maps the function name and function signature information, to determine a virtual address within the virtual address space of the LSRE 266, so as to enable the LSPM 262 determine the location within the virtual address space, of the executable code of this external function, being an LIF function, and to further determine how to call the LIF function with its arguments (parameters) in correct sequence and with correct data type(s) for those arguments, and to determine how to a return a data type of any return value provided from the LIF function, to the virtual machine (VM) 260, by employing the information provided by the function signature of this external function, being LIF function.

Upon completion of the performance (execution) of the one or more actions, via the language specific runtime environment (LSRE) 266, the LSPM 262 then accesses, reads and updates (modifies) 386 the state of execution 390 of the VM 260, as if the VM 260 itself performed the one or more actions directed by LIF function referred to by the byte code 252b, and then returns any value that is returned by the LIF function to the VM 260, and returns (transfers) the control of execution 388 from the LSPM 262 to the VM 260.

Upon the control of execution returning (transferring) 388 to the VM 260, the VM 260 then turns its attention to and inputs (fetches) the next byte code instruction 252c in the byte code program 252. The VM then inspects and classifies this third byte code 252c, as being associated with a non-intrinsic function (NIF), like the first byte code 252a, and processes the third byte code 252c without participation from the LSPM 262, and in a manner like the processing of the first byte code 252a by the VM 260.

The VM 260 continues to process all of the byte codes 252 that have been translated by the translator 252 and gathers information from processing the byte codes to enable performance (execution) of static analysis upon the information yielded from such processing of the byte codes 252, within a byte code program 252.

In some embodiments of invention, the operation of the LSPM 262 is expanded to further process function calls to other types of external functions, where the internal programming content of such external functions are not defined within the byte code program 252 that is output from the translator 250. These external functions, being defined by programming content that is located outside of the byte code program 252 that is output from the translator 250.

For example, translated source code can include one or more directives to call an operating system defined function (call), or directives to call a third party defined function, in addition to directives to call a language intrinsic function (LIF), which can be implemented as a language specific runtime environment (LSRE) defined function.

For processing an operating system call function, like the processing of a language intrinsic function (LIF), an operating system call function (OSCF) is named as a first parameter (argument) to a byte code instruction that directs a function call into an entry point of the applications programming interface (API) of the LSPM 262. Such an entry point can be the same entry point that processes the language intrinsic function (LIF), as described above.

The LSPM 262 then retrieves zero, one or more arguments (parameters) that are intended to be processed by the operating system call function (OSCF) and causes execution of the OSCF by performing a function call into an applications programming interface (API) of the operating system.

In some operating systems, the OSCF is defined inside of a library of defined operating system call functions (OSCF), where each (OSCF) is typically expressed (defined) in terms of executable binary machine code, that can be linked with the LSPM 262 prior to runtime of the SAP 110 and the LSPM 262, and executed during runtime of the SAP 110 and the LSPM 262, via exercising (executing) an entry point of the LSPM 262.

Each of these defined operating system call functions are typically designed (configured) to interrupt (trap into) the kernel of the operating system for processing by software residing within the operating system kernel, or designed (configured) for processing, in whole or in part, by software that resides within operating system software that resides outside of the kernel of the operating system.

Upon completion (return) of the execution of the operating system call function (OSCF), any return value provided by the OSCF is returned (communicated) to the virtual machine (VM) 260, upon completion of the processing by the virtual machine (VM) 260, of the byte code that directs processing of the OSCF.

For processing a call of a third party (provided) function (TPF), like the processing of a language intrinsic function (LIF), and like the processing of an operating system call function (OSCF), the third party (provided) function (TPF) is named as a first parameter (argument) to a byte code instruction that directs a function call into an entry point of the applications programming interface (API) of the LSPM 262. Such an entry point can be the same entry point that processes the language intrinsic function (LIF), as described above.

The LSPM 262 then retrieves zero, one or more arguments (parameters) that are intended to be processed by the third party (provided) function (TPF) and causes execution of the TPF by performing a function call into a file including the definition of the TPF. Such a file is typically, a library of defined third party (provided) functions, where each TPF is typically expressed (defined) in terms of executable binary machine code, that can be linked with the LSPM 262 prior to runtime of the SAP 110 and the LSPM 262, and executed during runtime of the SAP 110 and the LSPM 262, via exercising (executing) an entry point the LSPM 262.

Upon completion (return) of the execution of the third party (provided) function call (TPFC) any return value provided by the TPFC is returned (communicated) to the virtual machine (VM) 260, upon completion of the processing by the virtual machine (VM) 260, of the byte code that directs processing of the OSCF.

When processing any type of function that is defined external to the byte code program 252, referred to herein as an external function, the LSPM 262 is designed (configured) to receive a function name of such an external function, that is communicated from the virtual machine (VM) 260 to the LSPM 262, and the LSPM 262 is further designed (configured) to acquire a function signature of this external function, from information provided by the byte code 252b being processed by the virtual machine 260.

The LSPM maps the function name and function signature information to virtual address within the virtual address space of the static analyzer program (SAP) 110, so as to enable the LSPM 262 to determine the location within the virtual address space, of the executable code of this external function, and to further know how to call (execute) the external function with its arguments (parameters) in correct sequence and with correct data type(s) of those arguments, and to determine a return a data type of any return value provided from the external function, to be returned to the virtual machine (VM) 260 by the LSPM 262, by the LSPM 262 employing the knowledge of the function signature of this external function.

In some embodiments of the invention, and as indicated above, the virtual address space of the SAP 110 preferably includes the virtual address space of the virtual machine 260, the virtual address space of the LSPM 262, and of any operating system call functions (OSCF) and of any third-party software that the computer program 120 is designed (configured) to interoperate with.

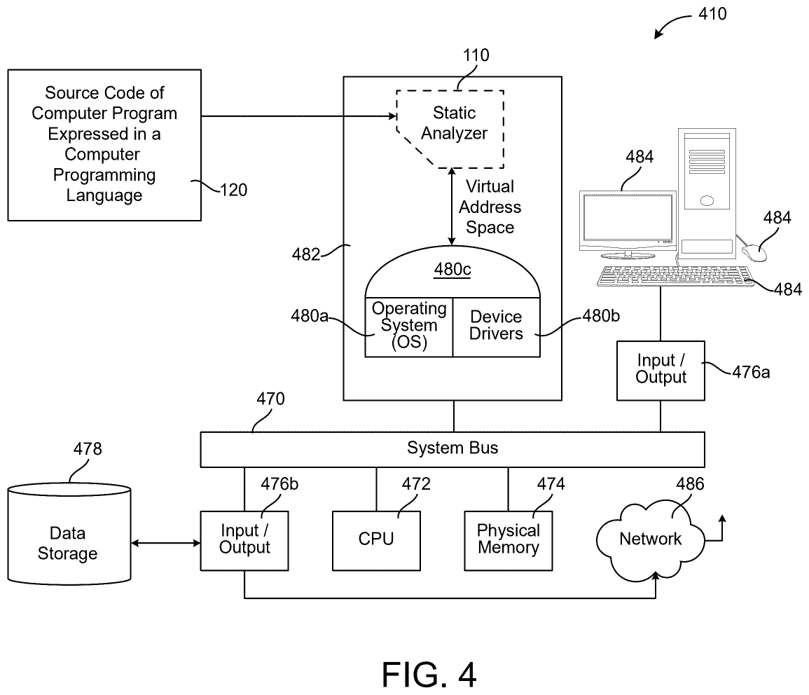

FIG. 4 illustrates a simplified representation of a computing environment within which the static analyzer program (SAP) 110 can operate. As shown, there is a computer system 410 including at least one central processing unit (CPU) 472 that stores and retrieves information from physical memory 474 and/or from non-volatile mass data storage 478. The CPU 472 also communicates information to various peripheral devices via input/output device interface hardware 476a-476b.

These various peripheral devices including the mass data storage device 478, user interface hardware 484, and a network communications interface hardware 486. The CPU 472, the physical memory 474 and the input/output device interface hardware 476a-476b, having a direct electronic connection with a system bus 470. The mass storage device 478, the user interface hardware 484 and the network communications interface hardware 486, having an indirect electronic connection to the system bus, 470, via the input/output device interface hardware 476a-476b.

Also as shown, an operating system 480a, along with its device drivers 480b and its application program interface (API) 480c, is loaded into the physical memory 474. The operating system 480a-480c establishes a virtual (memory) address space 482 for application software, such as static analyzer program (SAP) 110, to load into, to execute within and to inter-operate with the operating system and its device drivers 480a-480c, to interoperate with the hardware that the device drivers 480b interface with.

The SAP 110 interoperates with the operating system 480a-480c, and accesses source code of a computer program 120 to perform static analysis of the source code of the computer program 120. This source code can be expressed in one of many possible computer programming languages. This source code being stored onto and accessed from the mass data storage device 478.

In summary, the invention provides for a system, apparatus and method for performing static analysis of a computer program that is expressed as source code that is written in accordance with a plurality of one or more different computer programming languages.

The system, apparatus and method including a source code to byte code first translator program, the first translator program being designed (configured) to input source code expressed in accordance with a first computer programming language, the source code defines at least a first portion of a first computer program, and wherein the first translator program is further designed (configured) to output a first byte code into a first byte code program, the first byte code program being a representation of the first portion of the first computer program, and including a virtual machine (VM) being designed (configured) for inputting and for performing static analysis of the at least a portion of the first computer program, via the processing of the first byte code program.

The virtual machine being further designed (configured) to interoperate with at least a first language specific plugin module (LSPM), the first LSPM providing a first application programming interface (API) and designed (configured) to cause performance (execution) of one or more external functions, and wherein each of the external functions are called from within the first byte code program, and wherein each of the external functions are called while each of the external functions are defined outside of the first byte code program.

In some embodiments, the system, apparatus and method including a first language specific plugin module (LSPM) enabling the virtual machine (VM) to cause performance (execution) of one or more external functions that are each called from within said first byte code program, and wherein each of the external functions are defined within a first language specific runtime environment (LSRE) that is associated with the first computer programming language.

In some embodiments of the system, apparatus and method, the first language specific plugin module (LSPM) enabling the virtual machine (VM) to cause performance (execution) of one or more external functions that are each called from within the first byte code program, and wherein each of the external functions are operating system call functions that are each defined within software provided by a first operating system.

In some embodiments, the system, apparatus and method including the first language specific plugin module (LSPM) enabling said virtual machine (VM) to cause performance (execution) of one or more external functions that are each called from within said first byte code program, and wherein each of the external functions are defined within third party provided software.

In some embodiments, the system, apparatus and method including third party provided software including source code that is expressed in accordance with the first computer programming language, and that is directly function called from the first byte code program, and that is translated by the first translator program and output as the first byte code into the first byte code program.

In some embodiments, the system, apparatus and method including a source code to byte code second translator program, the second translator program being designed (configured) to input source code expressed in accordance with a second computer programming language, the source code defines at least a second portion of a first computer program, and wherein the second translator program is further designed (configured) to output the first byte code into the first byte code program, the first byte code program being a representation of the second portion of the first computer program.

In some embodiments, the system, apparatus and method including a second language specific plugin module (LSPM), the second LSPM providing a second application programming interface (API) and designed (configured) to cause performance (execution) of one or more external functions, and wherein each of the external functions are called from within the first byte code program, and wherein each of the external functions are called while each of the external functions are defined outside of the first byte code program.

In some embodiments, the system, apparatus and method including the second language specific plugin module (LSPM) enabling the virtual machine (VM) to cause performance (execution) of one or more external functions that are each called from within the first byte code program, and wherein each of the external functions are defined within a second language specific runtime environment (LSRE) that is associated with the second computer programming language.

In some embodiments, the system, apparatus and method wherein third party provided software is expressed in accordance with the second computer programming language, and is directly function called from the first byte code program, is translated by the second translator program and output as the first byte code into the first byte code program.

In some embodiments, the system, apparatus and method including a byte code to byte code third translator program, the third translator program being designed (configured) to input a second byte code expressed in accordance with a second byte code language, the second byte code defines at least a third portion of the first computer program, and wherein the third translator program is further designed (configured) to output the first byte code into said first byte code program, the first byte code program being a representation of the third portion of said first computer program.

In some embodiments, the system, apparatus and method wherein third party provided software is expressed in accordance with the second byte code language, and that is directly function called from the first byte code program, and is translated by the byte code to byte code third translator program and output as the first byte code into the first byte code program.

In other embodiment(s) of the invention, the invention provides for a system, apparatus and method for performing static analysis of a computer program that is expressed as set of byte code that is processed by a virtual machine.

The system, apparatus and method including a virtual machine that performs static analysis of a software application (computer program) that is expressed in byte code. The system and apparatus including, a virtual machine (VM) that is configured (designed (configured)) for inputting and for performing static analysis of said at least a portion of a first software application (computer program) that is expressed as a first byte code program, the static analysis being performed via the processing of the first byte code program.

The virtual machine being further designed (configured) to interoperate with at least a first language specific plugin module (LSPM), the first LSPM providing a first application programming interface (API) and (configured) designed (configured) to cause performance of one or more external functions, and wherein each of the external functions are called from within the first byte code program, and wherein each of the external functions are called while being (programmatically) defined and located and embodied, outside of the first byte code program.

In some embodiments, the first language specific plugin module (LSPM) enabling the virtual machine (VM) to cause performance (execution) of the one or more external functions that are each called from within the first byte code program, and wherein the external functions include one or more functions that are defined, located and embodied within a first language specific runtime environment (LSRE) that is associated with a first computer programming language.

In some embodiments, the first language specific plugin module (LSPM) enabling the virtual machine (VM) to cause performance of the one or more external functions that are each called from within the first byte code program, and wherein the external functions include one or more functions that are operating system call functions that are each (programmatically) defined, located and embodied) within software provided by a first operating system.

In some embodiments, the first language specific plugin module (LSPM) enabling the virtual machine (VM) to cause performance (execution) of the one or more external functions that are each called from within the first byte code program, and wherein the external functions include one or more functions that are (programmatically) defined (embodied) within third party provided software.

In some embodiments, the third party provided software is source code that is expressed in accordance with said first computer programming language, and that is translated by a first translator program and output as a first set of byte code into the first byte code program, and that is directly function called from the first byte code program.

In some embodiments, the system, apparatus and method including a byte code to byte code third translator program, the third translator program being designed (configured) to input a second set of byte code expressed in accordance with a second byte code language, the second set of byte code defines at least a portion of the first computer program, and wherein the third translator program is further configured designed (configured) to output a third set of byte code into the first byte code program, the first byte code program including the at least a portion of the first computer program.

In some embodiments, the system, apparatus and method including a third party provided set of software that is expressed in accordance with the second byte code language, and is translated by the byte code to byte code third translator program and output as a third set of byte code that is stored into the first byte code program, and the third set of byte code being directly function called from within the first byte code program.

This written description uses examples to disclose the invention, including the best mode, and to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A method for performing static analysis of a computer program that is expressed as source code that is written in accordance with at least one of a plurality of one or more different computer programming languages, the method including actions of:
providing a source code to byte code first translator program, said first translator program being designed to input source code expressed in accordance with a first computer programming language, said source code defines at least a first portion of a first computer program, and wherein said first translator program is further designed to output a first set of byte code into a first byte code program, said first byte code program being a representation of said first portion of said first computer program, and
providing a virtual machine (VM) being designed for inputting and for performing static analysis of said at least a portion of said first computer program, via said processing of said first byte code program, and wherein
said virtual machine being further designed to interoperate with at least a first language specific plugin module (LSPM), said first LSPM providing a first application programming interface (API) and designed to cause performance of one or more external functions, and wherein said external functions are each called from within said first byte code program, and wherein said external functions are defined outside of said first byte code program.

2. The method of claim 1, wherein said first language specific plugin module (LSPM) enabling said virtual machine (VM) to cause performance of said one or more external functions that are called from within said first byte code program, and wherein said external functions are defined within a first language specific runtime environment (LSRE) that is associated with said first computer programming language.

3. The method of claim 1, wherein said first language specific plugin module (LSPM) enabling said virtual machine (VM) to cause performance of said one or more external functions that are each called from within said first byte code program, and wherein said external functions are each defined within software provided by a first operating system.

4. The method of claim 1, wherein said first language specific plugin module (LSPM) enabling said virtual machine (VM) to cause performance of said one or more external functions that are called from within said first byte code program, and wherein said external functions are defined within third party provided software.

5. The method of claim 4, wherein said third party provided software includes source code that is expressed in accordance with said first computer programming language, and that is translated by said first translator program and output as a first set of byte code into said first byte code program, and that is directly function called from said first byte code program.

6. The method of claim 1 including a source code to byte code second translator program, said second translator program being designed to input source code expressed in accordance with a second computer programming language, said source code defines at least a second portion of said first computer program, and wherein said second translator program is further designed to output said first a second set of byte code into said first byte code program.

7. The method of claim 6 including a second language specific plugin module (LSPM), said second LSPM providing a second application programming interface (API) and designed to cause performance of one or more external functions, and wherein said external functions are called from within said first byte code program, and wherein said external functions are called while each of said external functions are defined outside of said first byte code program.

8. The method of claim 7, wherein said second language specific plugin module (LSPM) enabling said virtual machine (VM) to cause performance of said one or more external functions that are called from within said first byte code program, and wherein each of said external functions are defined within a second language specific runtime environment (LSRE) that is associated with said second computer programming language.

9. The method of claim 7, wherein said second language specific plugin module (LSPM) enabling said virtual machine (VM) to cause performance of said one or more external functions that are each called from within said first byte code program, and wherein said external functions are operating system call functions that are each defined within software provided by a first operating system.

10. The method of claim 7, wherein said second language specific plugin module (LSPM) enabling said virtual machine (VM) to cause performance of said one or more external functions that are each called from within said first byte code program, and wherein said external functions are defined within third party provided software.

11. The method of claim 7, wherein third party provided software that is expressed in accordance with said second computer programming language, and that is translated by said second translator program and output as a set of byte code into said first byte code program, and that is directly function called from said first byte code program.

12. The method of claim 1 including a byte code to byte code third translator program, said third translator program being designed to input a second byte code expressed in accordance with a second byte code language, said second byte code defining at least a portion of said first computer program, and wherein said third translator program is further designed to output said first byte code as a translation from said second byte code, into said first byte code program.

13. The method of claim 12, wherein third party provided software that is expressed in accordance with said second byte code language, and that is translated by said byte code to byte code third translator program and output as said first byte code into said first byte code program, and is directly function called from said first byte code program.

14. A system for performing static analysis of a computer program, the system including:
a virtual machine (VM) that is configured for inputting and for performing static analysis of at least a portion of a first computer program that is translated into a first byte code program, said static analysis being performed via said processing of said first byte code program, and wherein
said virtual machine being further designed to interoperate with at least a first language specific plugin module (LSPM), said first LSPM providing a first application programming interface (API) and designed to cause performance of one or more external functions, and wherein each of said external functions are called from within said first byte code program, and wherein each of said external functions are defined outside of said first byte code program.

15. The system of claim 14, wherein said first language specific plugin module (LSPM) enabling said virtual machine (VM) to cause performance of said one or more external functions that are each called from within said first byte code program, and wherein said external functions are defined within a first language specific runtime environment (LSRE) that is associated with said first computer programming language.

16. The system of claim 14, wherein said first language specific plugin module (LSPM) enabling said virtual machine (VM) to cause performance of said one or more external functions that are each called from within said first byte code program, and wherein each of said external functions are operating system call functions that are each defined within software provided by a first operating system.

17. The system of claim 14, wherein said first language specific plugin module (LSPM) enabling said virtual machine (VM) to cause performance of said one or more external functions that are each called from within said first byte code program, and wherein each of said external functions are defined within third party provided software.

18. The system of claim 17, wherein said third party provided software source code that is expressed in accordance with said first computer programming language, and that is translated by a first translator program and output as a first set of byte code into said first byte code program, and that is directly function called from said first byte code program.

19. The system of claim 14 including a byte code to byte code third translator program, said third translator program being designed to input a second set of byte code expressed in accordance with a second byte code language, said second set of byte code defines at least a portion of the first computer program, and wherein said third translator program is further designed to output a third set of byte code into said first byte code program, said first byte code program including a representation of said portion of said first computer program.

20. The system of claim 19, wherein a third party provided software that is expressed in accordance with said second byte code language, and that is translated by said byte code to byte code third translator program and output as a third set of byte code into said first byte code program, and wherein the third set of byte code being directly function called from said first byte code program.
